(19) United States
(12) Patent Application Publication
(10) Pub. No.: US 2013/0297125 A1
(43) Pub. Date: Nov. 7, 2013

(54) TORQUE FILLING AND TORQUE COORDINATION DURING TRANSIENTS IN A HYBRID VEHICLE

(71) Applicant: Ford Global Technologies, LLC, Dearborn, MI (US)

(72) Inventors: Fazal Urrahman Syed, Canton, MI (US); Mark Steven Yamazaki, Canton, MI (US); Francis Thomas Connolly, Ann Arbor, MI (US); Ming Lang Kuang, Canton, MI (US)

(21) Appl. No.: 13/829,701

(22) Filed: Mar. 14, 2013

Related U.S. Application Data
(60) Provisional application No. 61/643,740, filed on May 7, 2012.

(51) Int. Cl. B60W 20/00; B60W 10/08; B60W 10/06

(52) U.S. Cl. CPC B60W 20/40; B60W 10/06; B60W 10/08; B60W 2600/00; Y10S 903/93
USPC 701/22; 180/65.265; 903/930

(57) ABSTRACT

A system and method for controlling a vehicle powertrain is provided. The system and method sets a required transmission input torque during a transient event. A required traction motor torque and a required engine torque, in combination, are set to fulfill the required transmission input torque. The system and method includes estimates an actual engine torque during a delay in providing the required engine torque during the transient event. A transient traction motor torque is commanded based on a difference between the actual engine torque and the required transmission input torque. The commanded transient motor torque compensates for the delay in providing the required engine torque in order to prevent torque disturbances during the transient event.

### CROSS-REFERENCE TO RELATED APPLICATION

This application claims the benefit of U.S. Provisional Application No. 61/643,740, filed May 7, 2012, the contents of which are incorporated by reference herein.

### TECHNICAL FIELD

The present disclosure relates to torque filling and torque coordination in a hybrid vehicle powertrain.

### BACKGROUND

A hybrid electric vehicle powertrain includes an engine and an electric motor, wherein torque (or power) produced by the engine and/or by the motor can be transferred through a transmission to the vehicle drive wheels to propel the vehicle. A traction battery supplies energy to the motor for the motor to produce the (positive) motor torque for propelling the vehicle. The motor may provide negative motor torque to the transmission (for example, during regenerative braking of the vehicle) and thereby act as a generator to the battery. The engine may also provide negative engine torque to the transmission to provide engine braking for braking the vehicle.

In a modular hybrid transmission (“MHT”) configuration, the engine is connectable to the motor by a disconnect clutch and the motor is connected to the transmission. The engine, the disconnect clutch, the motor, and the transmission are connected sequentially in series.

### SUMMARY

According to one or more embodiments of the present disclosure, a method for controlling a vehicle powertrain is provided. The method includes setting a required transmission input torque during a transient event. A required traction motor torque and a required engine torque, in combination, are set to fulfill the required transmission input torque. The method includes estimating an actual engine torque during a delay in providing the required engine torque during the transient event. A transient traction motor torque is commanded based on a difference between the actual engine torque and the required transmission input torque. The commanded transient motor torque compensates for the delay in providing the required engine torque in order to prevent torque disturbances during the transient event.

In another embodiment, the method also includes, after the delay, commanding a traction motor torque to ramp from the transient motor torque to the required motor torque to achieve a steady state condition.

In a further embodiment, commanding the transient motor torque includes setting the transient traction motor torque to the required transmission input torque during a first delay period. The traction motor torque is also commanded to ramp from the required transmission input torque to the required motor torque during a second delay period to achieve a steady state condition.

In yet another embodiment, the method also includes commanding an engine torque to ramp from the actual engine torque to the required engine torque during the second delay period.

In still another embodiment, setting the required transmission input torque includes determining the required transmission input torque based on a driver request, powertrain system limits and a transmission output speed.

In a further embodiment, setting the required traction motor torque includes determining the required traction motor torque based on a battery capacity and a traction motor speed.

In another embodiment, setting the required engine torque includes determining the required engine torque based on the required traction motor and engine torque limits.

In yet another embodiment, estimating the actual engine delivered torque includes setting the actual engine delivered torque based on a previous engine delay response.

In still another embodiment, the method also includes determining the required traction motor torque and the required engine torque to fulfill the required transmission input torque in combination based on setting an optimum balance between an engine power and a high-voltage battery power during the steady state condition for the required transmission input torque.

According to one or more other embodiments of the present disclosure, a vehicle is provided. The vehicle includes a transmission and a traction motor and an engine for providing an input torque to the transmission. A controller is in communication with the motor and engine. The controller is configured to command the motor to apply a torque to compensate for a delay in the engine providing a required engine torque during a transient event. The motor torque minimizes torque disturbances during the transient event.

In another embodiment, the controller is configured to estimate the actual engine torque based on a previous engine delay response.

According to one or more additional embodiments of the present disclosure, a hybrid-vehicle powertrain control method is provided. The method includes commanding a fraction motor to apply a torque to compensate for a delay in an engine providing a required engine torque to fulfill a changed transmission input torque request during a transient event. The traction motor torque minimizes torque disturbances during the transient event.

### BRIEF DESCRIPTION OF THE DRAWINGS

FIG. 1 is a block diagram of an exemplary hybrid vehicle powertrain in accordance with an embodiment of the present disclosure;

FIG. 2A illustrates an example of a transmission output response of a vehicle to a change in driver demand;

FIG. 2B illustrates an example of a commanded transmission input based on the required transmission output in FIG. 2A;

FIG. 2C illustrates an example of an actual transmission input based on the required transmission output in FIG. 2A;

FIG. 3 is a flow chart illustrating a method in accordance with an embodiment of the present disclosure;

FIG. 4A illustrates an example of a commanded transmission output response of a vehicle to a change in driver demand employing the method illustrated in FIG. 3

FIG. 4B illustrates an example of a commanded transmission input based on the required transmission output in FIG. 4A; and

FIG. 4C illustrates an example of an actual transmission input based on the required transmission output in FIG. 4A.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

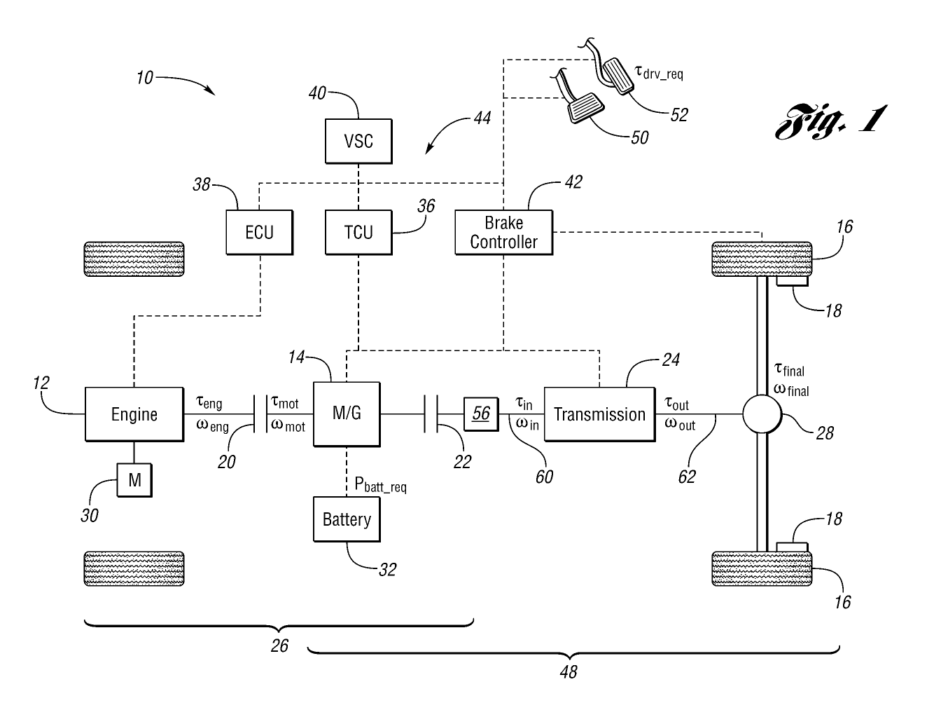

FIG. 1 illustrates a schematic diagram of a hybrid vehicle powertrain 10 according to an embodiment of the disclosure. The vehicle powertrain 10 includes an engine 12, and an electric machine, which, in the embodiment shown in FIG. 1, is a traction motor or motor-generator (M/G) 14. The M/G 14 is configured to transfer torque to the engine 12 or to the vehicle wheels 16. Each of the wheels 16 may include a friction brake device 18.

The M/G 14 is connected to the engine 12 using a first clutch 20, also known as a disconnect clutch or the upstream clutch. A second clutch 22, also known as a launch clutch or the downstream clutch, connects the M/G 14 to a transmission 24, and all of the input torque to the transmission 24 must flow through the launch clutch 22. The launch clutch 22 can be controlled to isolate the driveline 26, which includes the M/G 14 and the engine 12, from the transmission 24, differential 28 and the vehicle drive wheels 16. Although the clutches 20, 22 are described and illustrated as hydraulic clutches, other types of clutches, such as electromechanical clutches may also be used. Alternatively, the clutch 22 may be replaced with a torque converter and bypass clutch.

In the embodiment illustrated in FIG. 1, the transmission 24 is disposed between the M/G 14 and vehicle drive wheels 16. The M/G 14 can operate as a motor to provide torque to the vehicle wheels 16, and can also operate as a generator, receiving torque from the engine 12 and/or vehicle wheels 16, thereby charging a battery 32.

While FIG. 1 shows one example of a hybrid vehicle powertrain configuration, various other hybrid configurations are also contemplated. With regards to a full series type hybrid powertrain system, the engine may be operated to generate a form of energy suitable for use by the one or more motors. For example, with a full series type hybrid electric vehicle, the engine may generate electricity via a motor/generator that may be used to power an electric motor for propelling the vehicle. With regards to a parallel type hybrid propulsion system, the engine and one or more motors may be operated independently of each other. As one example, an engine may be operated to provide torque to the drive wheels, while a motor may be selectively operated to add or remove torque delivered to the wheels. As another example, the engine may be operated without the motor or the motor may be operated without the engine. Further, in addition to the embodiment in FIG. 1 it is also contemplated that the hybrid electric vehicle may have with either series or parallel type hybrid powertrain systems, or combinations thereof to cooperatively generate electric power as well as output torque.

The engine 12 is a direct injection engine. Alternatively, the engine 12 may be another type of engine or prime mover, such as a port injection engine, a fuel cell, or a second electric machine. The engine 12 may use various fuel sources, such as diesel, biofuel, natural gas, hydrogen, or the like.

In some embodiments, the vehicle powertrain 10 also includes a starter motor 30 operatively connected to the engine 12, for example, through a belt or gear drive. The starter motor 30 may be used to provide torque to start the engine 12 without the addition of torque from the M/G 14. This allows the upstream clutch 20 to isolate the M/G 14 during engine 12 start and may eliminate or reduce torque disturbances that would otherwise occur if torque is transferred from the M/G 14 to the engine 12 to assist the engine start.

The M/G 14 is in communication with a battery 32. The battery 32 may be a high voltage battery. The M/G 14 may be configured to charge the battery 32 in a regeneration mode, for example when a driver demands negative wheel torque, through regenerative powertrain braking, or the like. In one example the battery 32 is configured to connect to an external electric grid, such as for a plug-in electric hybrid vehicle (PHEV) with the capability to recharge the battery from an electric power grid, which supplies energy to an electrical outlet at a charging station.

In some embodiments, the transmission 24 is an automatic transmission and connected to the drive wheels 16 in a conventional manner, and may include a differential 28. The vehicle powertrain 10 is also provided with a pair of non-driven wheels, however, in alternative embodiments, a transfer case and a second differential can be utilized in order to positively drive all of the vehicle wheels.

The M/G 14 and the clutches 20, 22 may be located within a motor generator case 34 which may be incorporated into the transmission 24 case, or alternatively, is a separate case within the vehicle powertrain 10. The transmission 24 has a gear box to provide various gearing ratios for the vehicle powertrain 10. The transmission 24 gearbox may include clutches and planetary gear sets, or other arrangements of clutches and gear trains as are known in the art.

The transmission 24 is controlled using a transmission control unit (TCU) 36 to operate on a shift schedule, such as a production shift schedule, that connects and disconnects elements within the gear box to control the ratio between the transmission output and transmission input. The TCU 36 also acts to control the M/G 14, the clutches 20, 22, and any other components within the motor generator case 34.

The engine 12 output shaft is connected to the disconnect clutch 20, which in turn is connected to the input shaft for the input shaft to the M/G 14. The M/G 14 output shaft is connected to the launch clutch 22, which in turn is connected to the transmission 24. In the embodiment illustrated in FIG. 1, the components of driveline 26 of the vehicle powertrain 10 are positioned sequentially in series with one another.

An engine control unit (ECU) 38 is configured to control the operation of the engine 12. A vehicle system controller (VSC) 40 transfers data between the TCU 36 and ECU 38. The VSC is also in communication with various sensors for detecting the operating conditions of the engine 12 and transmission 24 such as throttle position sensors, mass air flow sensors, oxygen sensors, manifold pressure sensors or any other powertrain sensors for determining driver input and operating conditions of the battery 32 and M/G 14.

The VSC 40 may also communicate with or include a brake controller 42. The brake controller 42 may be connected with a variety of sensors including brake pedal sensors, accelerator pedal sensors or wheel speed sensors or any other brake system sensors. The brake controller 42 may control and operate friction brakes 18 for mechanical braking of the wheels 16. The brake controller 42 may also control the regenerative brake system 48. The regenerative brake system may include the M/G 14 driven by and driving the wheels 16 of an HEV and the battery 32.

The control system 44 for the vehicle powertrain 10 may include any number of controllers, and may be integrated into a single controller, or have various control modules. Some or all of the controllers may be connected by a controller area network (CAN) or other system. The control system 44 may be configured to control operation of the various components of the transmission 24, the motor generator assembly 34, the starter motor 30 and the engine 12 under any of a number of different conditions. For example, the control system 44 may control operation of the various systems and components in a way that minimizes or eliminates torque disturbances and impact to the driver.

Under normal powertrain conditions, the VSC 40 interprets the driver's demands, such as acceleration deceleration demand and then determines the wheel torque command based on the driver demand, powertrain and battery limits. In addition, the VSC 40 determines how much torque each power source needs to provide in order to meet the driver's torque demand, in order to maintain state of charge of the battery 32, and to achieve the operating point (torque and speed) of the engine 12.

Some hybrid electric vehicle configurations may control the engine 12, transmission 24, M/G 14 or any combination thereof, to provide powertrain braking during a braking request from the operator. A braking request may include any operator request to brake the vehicle during a braking event. Therefore a braking request from the operator may include depressing the brake pedal 50 for greater braking or merely releasing the accelerator pedal 52 during gradual or lower braking events.

As discussed above, when the M/G 14 provides powertrain braking, the M/G 14 creates negative torque to slow the vehicle during a braking period. In turn, M/G 14 generates electric energy (e.g. charge (Q) or current (I)) from braking the vehicle which may be transferred to the battery 32. When M/G 14 functions as the generator, kinetic or potential energy of the vehicle is converted to electric energy in order to brake the vehicle. This operation may be known as regenerative braking. In a HEV, regenerative powertrain braking may also be considered a type of powertrain braking.

One goal of the MHT powertrain is to provide the driver demand torque by coordinating engine 12 and the M/G 14 torque. Since, the delivery of desired driver demand torque requires coordination between the engine 12 and M/G 14 torque, any incorrect estimation of engine 12 torque can result in a mismatch in driver torque demand and even a torque hole. Thus, a so-called torque hole can be created when the output shaft torque does not correspond to the driver demand or the output shaft torque drops significantly. A large torque hole can be perceived by a vehicle occupant as sluggish powertrain performance or an unpleasant shift.

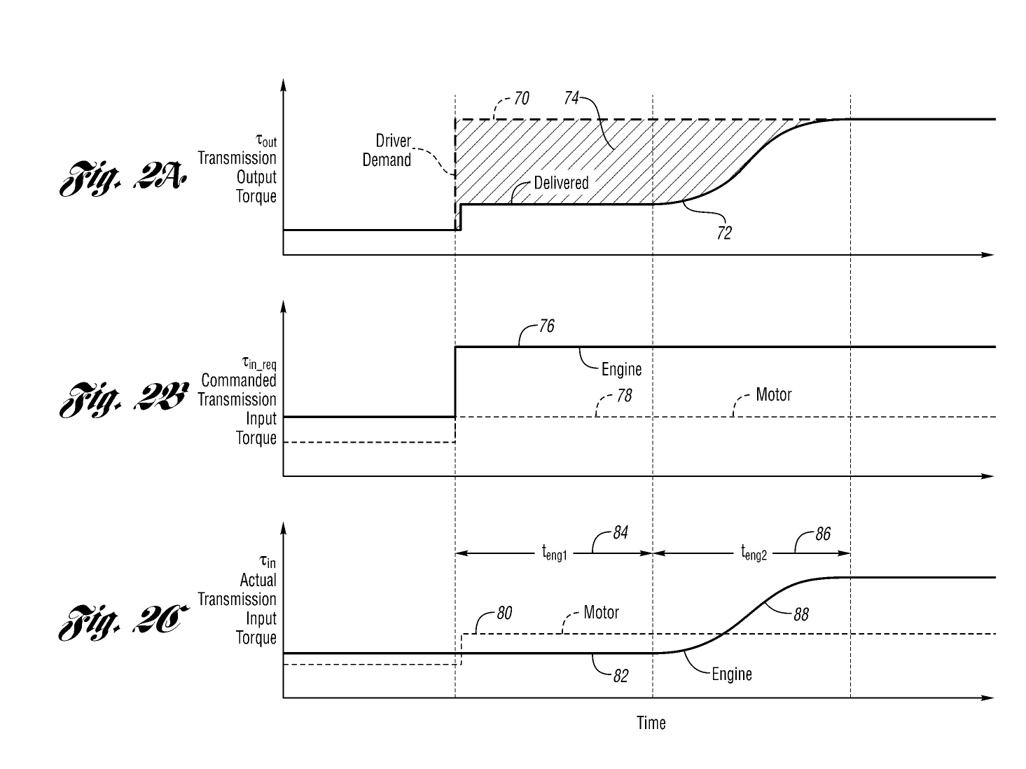

FIG. 2A illustrates a possible response of a hybrid vehicle powertrain to change in driver demand. The driver may demand a sudden or step-like increase in torque by pressing the accelerator pedal, as shown at 70 in the FIG. 2A. However, due to the slower response time of the engine, the delivered transmission output torque 72, does not correspond to the driver demand. The difference in demanded torque and delivered torque is considered a torque hole 74.

As shown in FIG. 2B, a controller may respond to the driver demand 70 by commanding a similar increase in engine torque 76 as well as an increase the motor torque 78. The motor may respond very quickly to this increase in commanded torque, as shown at 80 in FIG. 2C. However, there is a significant delay 82 before the internal combustion engine delivers the increased torque. As shown in FIG. 2C, during a first part of the delay 84, which lasts for a time t_{eng1} the engine torque 82 does not change at all.

During the second part of the delay 86, which lasts for a time t_{eng2}, the engine torque 88 gradually changes to the new value. Both delay times t_{eng1} and t_{eng2} are dependent on the engine speed. During this interval, the transmission output torque delivered 72 is substantially less than the driver's demanded torque 70, creating a torque disturbance 74 or torque-hole. Many drivers may find that this delayed reaction and torque disturbance makes the vehicle less enjoyable to drive.

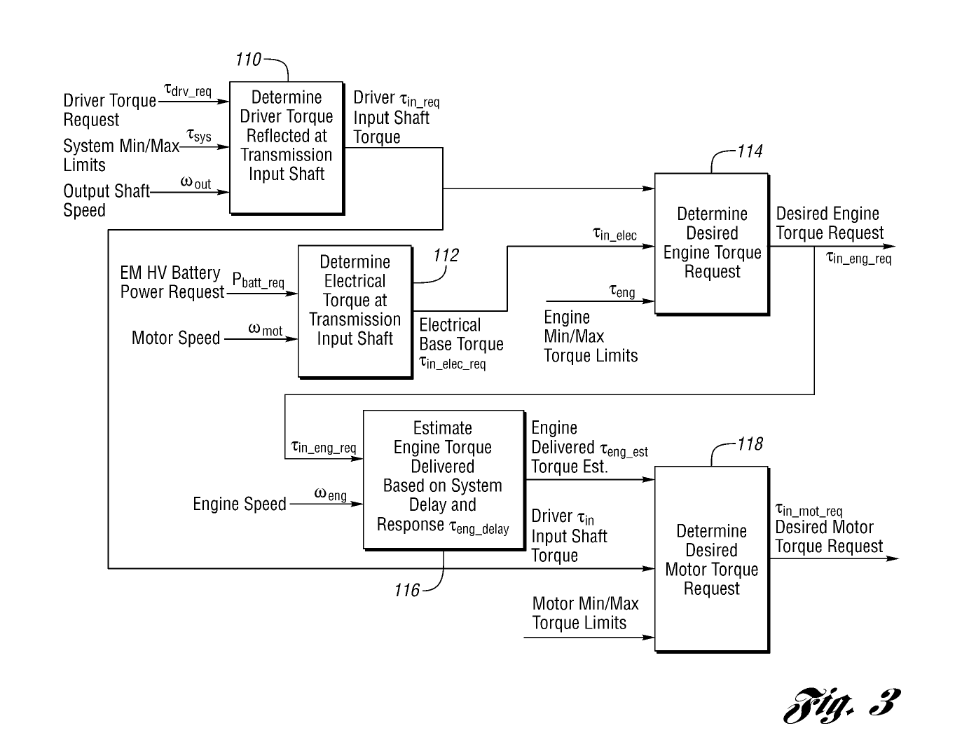

FIG. 3 shows a flow chart for a method of coordinating engine and transmission torque to improve the hybrid vehicle powertrain response to changes in driver demand. This procedure is repeated at regular intervals of tₗₒₒₚ. The driver torque request, τ_{drv}_{_{—}}_{req} may be determined as a function of accelerator pedal position, for example.

τ_{drv}_{_{—}}_{req}=f(v, pedal position)

The total transmission input torque, τᵢₙ_{_{—}}_{req}, required to satisfy the driver demand, τ_{drv}_{_{—}}_{req}, is computed at block 110. This computation considers the output shaft speed, ωₒᵤₜ, the driver request, τ_{drv}_{_{—}}_{req} the torque limits of the system, τ_{sys}, the transmission ratio, and estimated transmission losses, τₜᵣₐₙₛ_{_{—}}ₗₒₛₛ.

τ_{drv}_{_{—}}_{req}=flt(τ_{drv}_{_{—}}_{req}_{_{—}}_{unf}, t_{drv}_{_{—}}_{req})+τₜᵣₐₙₛ_{_{—}}ₗₒₛₛ

τᵢₙ_{_{—}}_{drv}_{_{—}}_{req}=τ_{drv}_{_{—}}_{req}*ωₒᵤₜ/ω_{eng}

where flt is a filtering function and τ_{drv}_{_{—}}_{req} is a filtering time constant. If τ_{drv}_{_{—}}_{req} is less than a minimum limit τ_{sys}_{_{—}}ₘᵢₙ or greater than a maximum limit τ_{sys}_{_{—}}ₘₐₓ, it is clipped to the respective limit is the transmission mechanical losses τₜᵣₐₙₛ_{_{—}}ₗₒₛₛ.

The required transmission input torque, τᵢₙ_{_{—}}_{req}, is considered as a steady state condition. In the steady state condition, the engine 12 and M/G 14 provide torque in combination to fulfill the required transmission input torque, τᵢₙ_{_{—}}_{req}. The engine 12 and M/G 14 provide torque based on setting an optimum balance between engine power and a high-voltage battery power during the steady state condition.

The portion of the required transmission input torque provided by the M/G14 is computed at block 112. The desired traction motor torque, or the electrical torque at the transmission input shaft, τᵢₙ_{_{—}}_{elec}_{_{—}}_{req}, considers the motor speed, ωₘₒₜ, estimated motor efficiency, and the present state of charge in the battery relative compared to a desired state of charge. For example, if the current battery charge is less than desired, then a negative torque would be requested such that the M/G 14 acts as a generator to charge the battery.

τᵢₙ_{_{—}}_{elec}_{_{—}}_{req}=P_{bat}_{req}/ω_{eng}

where=P_{bat}_{_{—}}_{req} is a power request from the battery 32 or the base energy management strategy. If τᵢₙ_{_{—}}_{elec}_{_{—}}_{req} is less than a torque limit of the traction motor 14, such as minimum limit τₘₒₜ_{_{—}}ₘᵢₙ_{_{—}}ₗᵢₘ or greater than a maximum limit τₘₒₜ_{_{—}}ₘₐₓ_{_{—}}ₗᵢₘ, the motor toque τₘₒₜ is clipped to the respective limit.

In block 114 in FIG. 3, the portion of the required transmission input torque provided by the engine is computed. The desired engine torque request, τᵢₙ_{_{—}}_{eng}_{_{—}}_{req}, can be calculated from driver input shaft torque request, τ_{drv}_{_{—}}_{req}, and electrical torque, τᵢₙ_{_{—}}_{elec}_{_{—}}_{req} at the transmission as follows:

τᵢₙ_{_{—}}_{eng}_{_{—}}_{req}=τ_{drv}_{_{—}}_{req}−τᵢₙ_{_{—}}_{elec}_{_{—}}_{req}

τᵢₙ_{_{—}}_{eng}_{_{—}}_{req}=flt(T_{eng}_{_{—}}_{req}_{_{—}}_{unf}, t_{eng}_{_{—}}_{req}_{_{—}}_{cal})

The desired engine torque τᵢₙ_{_{—}}_{eng}_{_{—}}_{req}, also takes into account the maximum and minimum limits of the engine 12.

During the transient event in response to change in driver demand, the engine 12 may not be able to respond instantaneously to the new desired engine torque. As a result, the torque actually delivered differs from the required engine torque τᵢₙ_{_{—}}_{eng}_{_{—}}_{req}.

An estimate of the engine torque actually delivered, τ_{eng}_{_{—}}ₑₛₜ, is computed at block 116. The actual engine torque delivered τ_{eng}_{_{—}}ₑₛₜ, takes into account the delay in providing the the required engine torque τᵢₙ_{_{—}}_{eng}_{_{—}}_{req}.

The estimate of the engine torque actually delivered, τ_{eng}_{_{—}}ₑₛₜ, can be determined in two delay stages. The first delay, τ_{eng1}, is treated as a pure delay by using the using the value of τ_{eng}_{_{—}}_{req} from a previous loop. The number of loops to look back, k, can be determined by a table lookup based on engine speed, ω_{eng}.

k=t_{eng1}/tₗₒₒₚ=f(ω_{eng})

τ_{eng}_{_{—}}_{delay}(n)=τ_{eng}_{_{—}}_{req}(n−k)

The second part of the delay is computed using a filtering function and a time constant, t_{eng}_{_{—}}ₑₛₜ which can be determined by a table lookup based on engine speed.

t_{eng}_{_{—}}ₑₛₜ=f(ω_{eng})

τ_{eng}_{_{—est}}=flt(T_{eng}_{_{—}}_{dly}, t_{eng}_{_{—}}ₑₛₜ)

Alternatively, the estimated actual engine torque, τ_{eng}_{_{—}}ₑₛₜ could be computed by other means or measured with a sensor without departing from the remainder of the method.

Finally, the motor torque requested, τₘₒₜ_{_{—}}_{req}, can be computed at block 118. the motor torque requested, τₘₒₜ_{_{—}}_{req}, may be determined by subtracting the estimated actual engine torque, τ_{eng}_{_{—}}ₑₛₜ, from the total transmission input torque required.

τᵢₙ_{_{—}}ₘₒₜ_{_{—}}_{req}=τᵢₙ_{_{—}}_{drv}_{_{—}}_{req}−τ_{eng}_{_{—}}ₑₛₜ

τᵢₙ_{_{—}}ₘₒₜ_{_{—}}_{req}=flt(τₘₒₜ_{_{—}}_{req}_{_{—}}_{unf}, τₘₒₜ_{_{—}}_{req}_{_{—}}_{cal})

Consequently, the commanded motor torque τₘₒₜ_{_{—}}_{req} differs from the desired motor torque by the difference between the required engine torque, τᵢₙ_{_{—}}_{eng}_{_{—}}_{req}, and the estimated actual engine torque, τ_{eng}_{_{—}}ₑₛₜ.

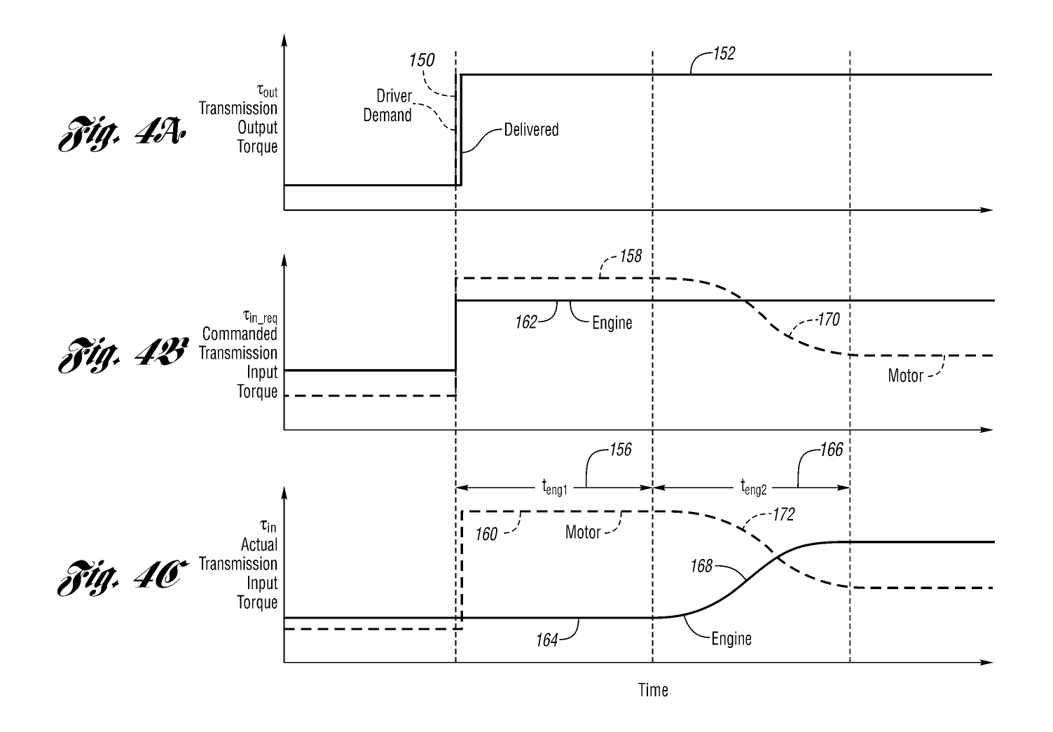

FIGS. 4A-4C illustrate the response of a hybrid vehicle powertrain when implementing the process described in FIG. 3 to minimize torque holes. As shown in FIG. 4A, in response to a change in driver demand 150, the delivered transmission output torque 152 is may be achieved using the disclosed method in FIG. 3.

As shown in in FIG. 4B, during the engine delay interval 156 before the engine responds to the increased torque request, the motor torque command 158 is increased such that the total delivered motor torque is very close, or substantially the same as the driver demand 150. Due to the quick response of the traction motor, the actual transmission input torque from the motor 160, shown in the FIG. 4B, is substantially the same as the commanded motor torque 158.

The engine torque commanded 162 is also increased in response to the driver demand 150. As shown in FIG. 4C, due to the slow engine response, the actual transmission input torque from the engine 164 does not increase quickly or remains relatively unchanged during the first delay interval 156.

During the second part of the delay 166, the engine torque 168 to the transmission gradually increases. Concurrently, during the second delay period 166, the commanded motor torque 170 is decreased, thereby decreasing the actual motor torque 172 to the transmission.

During the second delay period 166, the engine torque 168 and the motor torque 172 to the transmission is coordinated and combined so that the driver demanded torque 150 and actually delivered torque 152 of the transmission output are remain generally equal and consistent. This eliminates any torque disturbances that may have been felt by the driver and may make the hybrid vehicle so that drivers may find that more enjoyable to drive.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed:

1. A method for controlling a vehicle powertrain, the method comprising:
setting a required transmission input torque during a transient event; and
setting a required traction motor torque and a required engine torque in combination to fulfill the required transmission input torque; and
estimating an actual engine torque during a delay in providing the required engine torque during the transient event; and
commanding a transient traction motor torque based on a difference between the actual engine torque estimate and the required transmission input torque to compensate for the delay in providing the required engine torque in order to prevent torque disturbances during the transient event.

2. The method of claim 1 further comprising, after the delay, commanding a traction motor torque to ramp from the transient motor torque to the required motor torque to achieve a steady state condition.

3. The method of claim 1 wherein commanding the transient motor torque includes:
setting the transient traction motor torque to the required transmission input torque during a first delay period; and
commanding a traction motor torque to ramp from the required transmission input torque to the required motor torque during a second delay period to achieve a steady state condition.

4. The method of claim 3 further comprising, commanding an engine torque to ramp from the actual engine torque to the required engine torque during the second delay period.

5. The method of claim 1 wherein setting the required transmission input torque includes determining the required transmission input torque based on a driver request, powertrain system limits and a transmission output speed.

6. The method of claim 1 wherein setting the required traction motor torque includes determining the required traction motor torque based on a battery capacity and a traction motor speed.

7. The method of claim 6 wherein setting the required engine torque includes determining the required engine torque based on the required traction motor and engine torque limits.

8. The method of claim 1 estimating the actual engine delivered torque includes setting the actual engine delivered torque based on a previous engine delay response.

9. The method of claim 1 further comprising determining the required traction motor torque and the required engine torque to fulfill the required transmission input torque in combination based on setting an optimum balance between an engine power and a high-voltage battery power during the steady state condition for the required transmission input torque.

10. A vehicle comprising:
a transmission;
a traction motor and an engine for providing an input torque to the transmission; and
a controller in communication with the motor and engine and configured to:
command the motor to apply a torque to compensate for a delay in the engine providing a required engine torque during a transient event, wherein the motor torque minimizes torque disturbances during the transient event.

11. The vehicle of claim 10, wherein the motor torque is based on a difference between an actual delivered engine torque and a required transmission input torque.

12. The vehicle of claim 11 wherein the controller is configured to:
after the delay, command the motor torque to ramp to a required motor torque to achieve a steady state condition, wherein the required engine torque and the required motor torque provide the required transmission input torque in combination.

13. The vehicle of claim 10 wherein the controller being configured to command the motor to apply a torque includes the controller configured to:
set the motor torque to the required transmission input torque during a first delay period; and
command the motor torque to ramp from the required transmission input torque to a required motor torque during a second delay period to achieve a steady state condition.

14. The vehicle of claim 11 wherein the controller is configured to:
estimate the actual engine torque based on a previous engine delay response.

15. A hybrid-vehicle powertrain control method comprising:
commanding a traction motor to apply a torque to compensate for a delay in an engine providing a required engine torque to fulfill a changed transmission input torque request during a transient event, wherein the traction motor torque minimizes torque disturbances during the transient event.

16. The method of claim 15, wherein the traction motor torque is based on a difference between an actual delivered engine torque and a required transmission input torque.

17. The method of claim 16 further comprising:
after the delay, commanding the traction motor torque to ramp to a required motor torque to achieve a steady state condition, wherein the required engine torque and the required motor torque provide the required transmission input torque in combination.

18. The method of claim 16 further comprising:
setting the traction motor torque to the required transmission input torque during a first delay period; and
commanding the traction motor torque to ramp from the required transmission input torque to a required motor torque during a second delay period to achieve a steady state condition.

19. The method of claim 18 further comprising:
commanding an engine torque to ramp from the actual engine torque to the required engine torque during the second delay period.

20. The method of claim 18 further comprising:
estimating the actual engine torque based on a previous engine delay response.
